(19) United States
(12) Patent Application Publication
(10) Pub. No.: US 2006/0007718 A1
(43) Pub. Date: Jan. 12, 2006

(54) Power supply apparatus providing medium voltage direct current

(75) Inventor: Chin-Wen Chou, Taipei Hsien (TW)

Correspondence Address: BIRCH STEWART KOLASCH & BIRCH, PO BOX 747, FALLS CHURCH, VA, 22040-0747, US

(73) Assignee: Zippy Technology Corp.

(21) Appl. No.: 11/223,116

(22) Filed: Sep. 12, 2005

Related U.S. Application Data
(63) Continuation-in-part of application No. 10/444,969, filed on May 27, 2003, now Pat. No. 6,954,008.

(51) Int. Cl. H02M 7/00

(52) U.S. Cl. 363/125

(57) ABSTRACT

A power supply apparatus capable of providing medium voltage direct current to provide medium voltage and low voltage direct current includes a power supply input unit, a rectification unit and a conversion unit. The power supply input unit delivers AC voltage to the rectification unit which rectifies and outputs medium voltage DC. A portion of the medium voltage DC is further transformed by the conversion unit such that the whole DC power supply apparatus not only supplies low voltage power also directly supplies medium voltage power to enhance flexibility and efficiency of power supply for information appliances in the PC era.

This application is a continuation-in-part, and claims priority, of from U.S. patent application Ser. No. 10/444,969 filed on May 27, 2003, entitled “Integrated power supply apparatus for information appliances”.

### FIELD OF THE INVENTION

The present invention relates to a power supply apparatus capable of providing medium voltage direct current and particularly to a power supply apparatus that provides low voltage electric power as well as medium voltage electric power to enable the whole power supply apparatus to reduce power loss when supplying power to household appliances and improve performance.

### BACKGROUND OF THE INVENTION

The general power supply devices for PC mainly provide multiple sets of low voltage direct current (DC). However, in the era of PC information appliances, the low voltage DC power supply adopted in the PC architecture is inefficient and inflexible.

At present many new information appliance products have become increasingly popular, such as plasma TV, liquid crystal display, and the like. In these products, aside from various electronic circuits, the power supply devices to support the information appliances provide only lower voltage electric power. Refer to FIG. 1 for a conventional power supply for the back light panel of a liquid crystal display. The back light panel includes cold cathode fluorescent lamps (CCFLs) that require a high voltage (as high as hundred or even thousand volts) to activate.

The conventional design generally obtains the high-watt power from a low voltage end 12V(5V) of a conversion unit (the large size liquid crystal display requires a lot of lamp tubes, some could reach 20 or 30). Hence the low voltage power supply module could require power over hundred watts. To obtain the needed power supply from the power supply end of a low voltage power supply module requires a low efficient DC to DC conversion unit to transform a medium voltage (150-300V) to a low voltage, then to process through a voltage boosting unit consisting of an inverter. The resulting high voltage is used to activate the lamp tubes to light the back light panel of the liquid crystal display. Such a process causes a great loss for the power supply devices of the information appliances. Performance also cannot be improved.

### SUMMARY OF THE INVENTION

The primary object of the invention is to resolve the aforesaid disadvantages and eliminate the drawbacks of the prior art. The power supply apparatus for information appliances of the invention directly provides a medium voltage DC output to enable the whole DC power supply apparatus not only to provide low voltage electric power also directly provide medium voltage power supply to allow power supply for information appliances in the PC era more flexible and efficient.

To achieve the foregoing object, the invention provides an integrated power supply apparatus for information appliances. It includes a power supply input unit, a rectification unit and a conversion unit. The power supply input unit delivers an AC voltage to the rectification unit which rectifies and outputs medium voltage DC. A portion of the medium voltage DC is processed again by the conversion unit to provide a low voltage power supply. Thus it can provide both low voltage and medium voltage power supply.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a circuit block diagram of a conventional integrated power supply apparatus for information appliances.

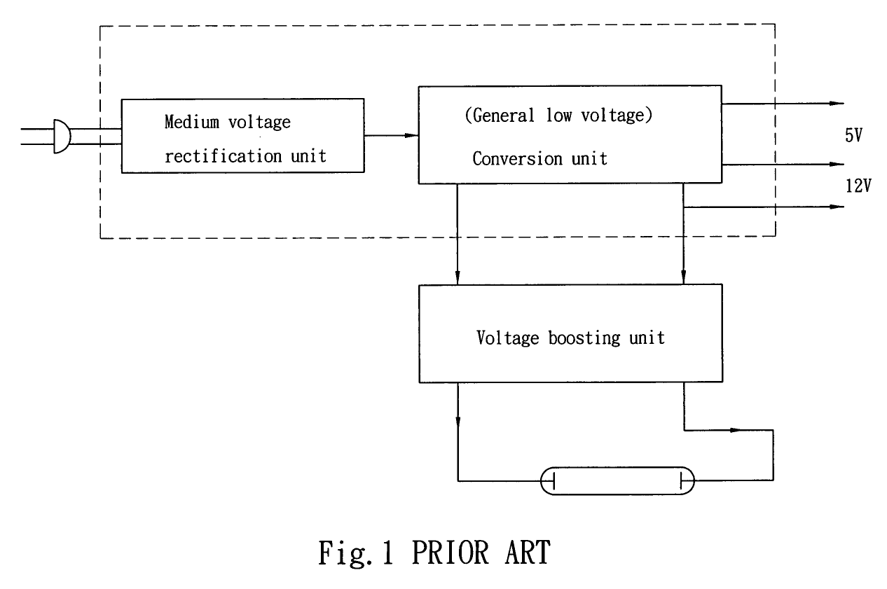

FIG. 2 is a circuit block diagram of the present invention that provides medium voltage DC power supply.

FIG. 3 is a circuit diagram of another embodiment of the present invention.

FIG. 4 is a circuit diagram of yet another embodiment of the present invention.

### DETAILED DESCRIPTION OF THE PREFERRED EMBODIMENTS

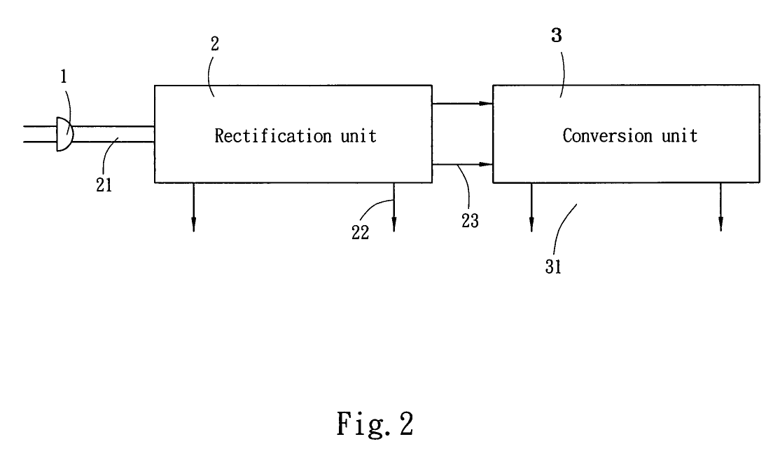

Please refer to FIG. 2 for the circuit block diagram of the present invention that provides medium voltage DC power supply. As shown in the figure, the power supply apparatus of the invention includes a power supply input unit 1, a rectification unit 2 and a conversion unit 3. The rectification unit 2 has an output end directly supplies a medium voltage DC to expand the conventional design of power supply that offers only low voltage so that users have more flexibility in applications, and in the mean time power loss is reduced and performance increases.

In the structure of the invention set forth above, the power supply input unit 1 provides AC voltage of 110-220V.

The rectification unit 2 has an input end 21 to receive input from the AC power supply. The rectification unit 2 rectifies the AC power to become a medium voltage DC in a range about 150 DCV and 300 DCV to be output. The rectified DC voltage are output through a first output end 22 and a second output end 23.

The conversion unit 3 is connected to the second output end 23 of the rectification unit 2 to transform the medium voltage DC output from the rectification unit 2 to a low voltage (such as 5V, ±12V, ±24V, etc.) DC 31 output to supply other circuits that require low voltage DC.

When the power supply input unit 1 delivers AC power supply input to the rectification unit 2, the rectification unit 2 rectifies the AC power supply to a medium voltage DC power supply (150 DCV-300 DCV) to be output. A portion of the medium voltage DC is output to the conversion unit 3 which transforms to a low voltage DC 31 to be output. Thus the whole DC power supply apparatus not only provides a low voltage power supply, it also directly supplies medium voltage power. Therefore power supply for the information appliances in the PC era is more flexible and efficient.

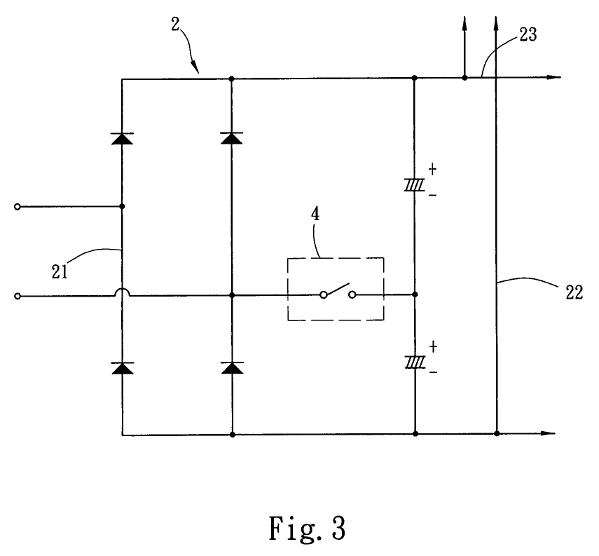

Refer to FIG. 3 for another embodiment of the invention. The integrated power supply apparatus for information appliances of the invention employs a rectification unit 2 which rectifies AC voltage to a medium voltage DC for outputting. The rectification unit 2 may be a half-wave bridge rectification or a full-wave bridge rectification, or adopt a voltage regulator approach to transform the AC voltage to a medium voltage DC for outputting.

In the mean time, the half-wave bridge rectification or the full-wave bridge rectification is bridged by a switch unit 4 which may be a mechanical type or an electronic type. When the rectification unit 2 is the half-wave bridge rectification or the full-wave bridge rectification, the switch unit 4 provides the switch function.

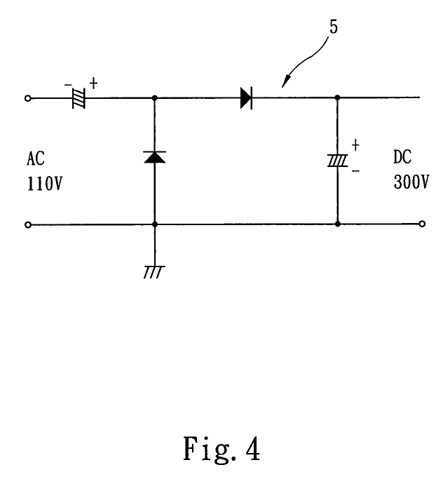

Refer to FIG. 4 for yet another embodiment of the invention. The integrated power supply apparatus for information appliances of the invention employs a rectification unit 2 which includes a half-wave or full-wave voltage doubling unit 5 that consists of at least one capacitor and diode to double the input AC voltage to become a medium voltage DC for outputting.

Moreover, the conversion unit 3 used in the invention may be multiple sets, a single set, or a positive and negative power supply type.

What is claimed is:

1. A power supply apparatus for providing medium voltage direct current to rectify and output a medium voltage direct current, comprising:
a power supply input unit to input an alternating current voltage; and
a rectification unit connected to an input end of the power supply input unit for rectifying the alternating current voltage to medium voltage direct current to be output such that the power supply apparatus supplies low voltage power as well as medium voltage power.

2. The power supply apparatus of claim 1, wherein the voltage of the medium voltage direct current ranges from 150 DCV to 300 DCV.

3. The power supply apparatus of claim 1, wherein the rectification unit is a half-wave bridge rectification, a full-wave bridge rectification or a voltage regulating rectification.

4. The power supply apparatus of claim 3, wherein the half-wave bridge rectification or the full-wave bridge rectification is bridged by a switch unit.

5. The power supply apparatus of claim 4, wherein the switch unit is a mechanical type or an electronic type.

6. The power supply apparatus of claim 1, wherein the rectification unit uses a half-wave or a full-wave voltage doubling unit that consists of at least one capacitor and diode to double input alternating current voltage to become the medium voltage direct current for outputting.

7. The power supply apparatus of claim 1 further having a conversion unit for transforming the medium voltage direct current to a low voltage for outputting.

8. The power supply apparatus of claim 7, wherein the conversion unit is in the form of multiple sets, a single set, or a positive and negative power supply.
